(19) United States
(12) Patent Application Publication
(10) Pub. No.: US 2013/0174426 A1
(43) Pub. Date: Jul. 11, 2013

(54) POWER TOOL CLAMPING DEVICE

(71) Applicant: Robert Bosch GmbH, Stuttgart (DE)

(72) Inventors: Daniel Saegesser, Langenthal (CH); Aldo Di Nicolantonio, Recherswil (CH); Giuseppe Fragapane, Solothurn (CH)

(73) Assignee: Robert Bosch GmbH, Stuttgart (DE)

(21) Appl. No.: 13/736,105

(22) Filed: Jan. 8, 2013

(30) Foreign Application Priority Data
Jan. 10, 2012 (DE) 10 2012 200 222.7

(51) Int. Cl. B25F 5/00

(52) U.S. Cl. CPC B25F 5/00
USPC 30/337; 30/329

(57) ABSTRACT

A clamping device of a reciprocating power tool includes at least one clamping unit, which has at least one working-tool receiving element and has a variation element, disposed on the working-tool receiving element, for varying at least one parameter of the working-tool receiving element. The variation element is movably mounted on the working-tool receiving element and/or has at least two mutually differing working-tool receiving contours.

This application claims priority under 35 U.S.C. §119 to patent application DE 10 2012 200 222.7, filed on Jan. 10, 2012 in Germany, the disclosure of which is incorporated herein by reference in its entirety.

### BACKGROUND

Already known from U.S. Pat. No. 6,453,565 B1 is a power-tool clamping device, in particular a clamping device of a reciprocating power tool, which device comprises a clamping unit having a working-tool receiving element and having a variation element that is disposed on the working-tool receiving element, at least in one operating state, for varying at least one parameter of the working-tool receiving element.

### SUMMARY

The disclosure is based on a power-tool clamping device, in particular a clamping device of a reciprocating power tool, having at least one clamping unit, which has at least one working-tool receiving element and has a variation element, disposed on the working-tool receiving element, for varying at least one parameter of the working-tool receiving element.

It is proposed that the variation element is movably mounted on the working-tool receiving element and/or has at least two mutually differing working-tool receiving contours. A “clamping unit” in this case is to be understood to mean, in particular, a unit that secures a working tool by means of a form closure and/or by means of a force closure for the purpose of working a workpiece, in particular at least partially by means of the working-tool receiving element of the clamping unit, which receiving element is provided to receive, at least partially, a shank of the working tool. “Provided” is to be understood to mean, in particular, specially configured and/or specially equipped. The expression “working-tool receiving element” is intended here to define, in particular, an element provided to receive the working tool, in particular the shank of the working tool, to enable the working tool to be fixed. Preferably, the shank of the working tool in this case is disposed on the working-tool receiving element by means of a form closure connection. It is also conceivable, however, for the shank to be disposed on the working-tool receiving element by means of another type of connection considered appropriate by persons skilled in the art. The term “variation element” is intended here to define, in particular, an element that, through alteration of a position of the variation element on the working-tool receiving element, or through provision of at least two mutually differing working-tool receiving contours, can vary a parameter of the working-tool receiving element acting in combination with the variation element. The parameter of the working-tool receiving element is preferably constituted by a geometric dimension of the working-tool receiving element, or by a capability to receive working tools that differ, at least in respect of a configuration of a shank. It is also conceivable, however, for the parameter of the working-tool receiving element to be constituted by another parameter considered appropriate by persons skilled in the art, such as, for example, an electrical and/or electronic parameter for the purpose of coding the working-tool receiving element in respect of a capability of the working tool to be disposed on the working-tool receiving element.

“Movably mounted” is to be understood here to mean, in particular, a mounting of a component, in particular the variation element, relative to a further component, in particular the working-tool receiving element, wherein the component, in particular decoupled from an elastic deformation of the component, has a capability to move along at least one axis, relative to the further component, along a travel distance, delimited in at least two oppositely oriented directions and extending along the axis, greater than 1 mm, preferably greater than 5 mm, and particularly preferably greater than 10 mm, and/or has a capability to move about at least one axis, by an angle greater than 1°, preferably greater than 2°, and particularly preferably greater than 5°, the movement path of the component being defined as a result of the mounting. Particularly preferably, the variation element, as a result of being movably mounted relative to the working-tool receiving element, is disposed on the working-tool receiving element at least substantially in each operating state, in particular in an operating state in which the working tool has been decoupled from the clamping unit. Therefore, apart from an operating state of the power-tool clamping device that corresponds to complete demounting, the variation element preferably remains disposed on the working-tool receiving element at least substantially in each operating state after the working tool has been decoupled from the working-tool receiving element. Preferably, the clamping unit comprises at least one securing element, which holds the variation element at least in a captive manner on the working-tool receiving element.

Preferably, one of the working-tool receiving contours of the variation element is realized so as to correspond, respectively, to a contour, in particular an outer contour, of a shank of at least two mutually differing shanks of two differing working tools. The configuration of the power-tool clamping device according to the disclosure makes it possible, advantageously, to achieve a high degree of flexibility in respect of a possible field of application of the power-tool clamping device. Advantageously, mutually differing working tools can be fixed by means of the power-tool clamping device in order to work a workpiece by means of a power tool having the power-tool clamping device according to the disclosure. Further, in particular owing to the fact that the variation element is movably mounted on the working-tool receiving element, it is possible for the variation element to be disposed in a captive manner on the working-tool receiving element after the working tool has been decoupled from the working-tool receiving element. Advantageously, therefore, the possibility of variation of the working-tool receiving element can be achieved in a reliable manner, since, advantageously, it is possible to prevent the variation element from becoming lost after the working tool has been decoupled from the working-tool receiving element. In addition, in particular by means of a configuration of the variation element having at least two mutually differing working-tool receiving contours, it is possible, in a structurally simple manner, to achieve a wide spectrum of application of the power-tool clamping device according to the disclosure, which configuration enables utilization for coupling at least two differing types of working-tool shanks to the power-tool clamping device.

Furthermore, it is proposed that the variation element is movably mounted in a working-tool receiving recess of the working-tool receiving element. A “working-tool receiving recess” is to be understood here to mean, in particular, a region of the working-tool receiving element that has at least a lesser material thickness than edge regions of the working-tool receiving element that delimit the region. In this way, advantageously, the variation element can be mounted in a structurally simple manner. In addition, advantageous guidance of the variation element can be achieved during a movement of the variation element.

Advantageously, the clamping unit has at least one movement delimiting element, which delimits a movement distance of the variation element, as viewed along a direction oriented opposite to a coupling direction of at least one working tool, relative to the working-tool receiving element. Preferably, the movement delimiting element extends, at least substantially transversely in relation to a movement path of the variation element, into the working-tool receiving element. “Substantially transversely” is to be understood here to mean, in particular, an orientation of a direction and/or of an axis relative to a reference direction and/or to a reference axis, the orientation of the direction and/or of the axis being at least different from an at least substantially parallel alignment in relation to the reference direction and/or to the reference axis and, in particular, being askew or perpendicular in relation to the reference direction and/or to the reference axis. Particularly preferably, the movement delimiting element is realized as a pin or a bolt, which constitutes a stop point or a stop surface for the variation element. It is also conceivable, however, for the movement delimiting element to be of a different configuration, considered appropriate by persons skilled in the art. Advantageously, the variation element can be secured against becoming lost. Advantageously, therefore, after a shank of a working tool has been removed, the movement delimiting element thereon prevents the variation element from being moved out of the working-tool receiving element.

Further, it is proposed that the clamping unit has at least one energy storage element, which applies a force to the variation element in at least one direction oriented opposite to a coupling direction of at least one working tool. An “energy storage element” is to be understood here to mean, in particular, an element that is provided, as a result of a movement of the variation element contrary to a direction of force along which there flows a force of the energy storage medium acting upon the variation element, to store potential energy and, in at least one operating state, to deliver this energy, in the form of kinetic energy, to the variation element. The energy storage element in this case can be realized as a gas compression spring, as an oil compression spring, etc. It is also conceivable, however, for the power-tool clamping device, instead of having the energy storage device, to have an actuator element such as, for example, a positioning motor, etc., which, at least in one operating state, applies to the variation element a force flowing along the direction oriented opposite to the coupling direction of at least one working tool. It is possible, advantageously, to achieve an at least substantially automatic resetting of the variation element to at least one position corresponding to an operating state.

Particularly preferably, the energy storage element is realized as a spring element. A “spring element” is to be understood to be, in particular, a macroscopic element having at least one extent that, in a normal operating state, can be varied elastically by at least 10%, in particular by at least 20%, preferably by at least 30%, and particularly advantageously by at least 50% and that, in particular, generates a counter-force, which is dependent on the variation of the extent and preferably proportional to the variation, and which counteracts the variation. An “extent” of an element is to be understood to be, in particular, a maximum distance of two points of a perpendicular projection of the element on to a plane. A “macroscopic element” is to be understood to be, in particular, an element having an extent of at least 1 mm, in particular of at least 5 mm, and preferably of at least 10 mm. Preferably, the spring element is realized as a compression spring. It is also conceivable, however, for the spring element to be of a different configuration, considered appropriate by persons skilled in the art, such as, for example, being configured as a tension spring, etc. The configuration according to the disclosure makes it possible, advantageously, for a resetting function of the variation element to be realized in an inexpensive manner.

In addition, it is proposed that the power-tool clamping device comprises at least one driving-force transmission element, the variation element being realized so as to be integral with the driving-force transmission element. A “driving-force transmission element” is to be understood here to mean, in particular, an element that, during operation of a power tool provided with the power-tool clamping device, transmits a driving force from a drive unit of the power tool to a working tool fixed to the clamping unit, in particular a working tool fixed in the working-tool receiving recess of the working-tool receiving element. The driving-force transmission element is preferably constituted by a lift rod. The lift rod is preferably directly or indirectly connected to a drive element, in particular an armature shaft, of the drive unit. It is also conceivable, however, for the driving-force transmission element to be of a different configuration, considered appropriate by persons skilled in the art, such as, for example, being configured as an output shaft, etc. Particularly preferably, the driving-force transmission element is provided to drive the working tool, fixed to the clamping unit, along the output axis in a reciprocating manner. “Integral with” is to be understood to mean, in particular, connected at least in a materially bonded manner, for example by a welding process, an adhesive process, an injection process and/or another process considered appropriate by persons skilled in the art, and/or, advantageously, formed in one piece such as, for example, by being produced from a casting and/or by being produced in a single or multi-component injection process and, advantageously, from a single blank. Particularly preferably, therefore, the at least two mutually differing working-tool receiving contours of the variation element are realized so as to be integral with the driving-force transmission element. The configuration of the power-tool clamping device according to the disclosure makes it possible, advantageously, to realize savings in structural space, costs and assembly work.

Advantageously, the mutually differing working-tool receiving contours are disposed so as to be offset in an at least substantially parallel manner in relation to each other. In this case, an overall course of one of the working-tool receiving contours is disposed, respectively, in one of two planes that extend at least substantially parallelwise in relation to a direction of movement of the variation element and/or to a direction of movement of the driving-force transmission element, and that extend at least substantially parallelwise in relation to each other. It is possible, advantageously, to achieve a space-saving disposition of the working-tool receiving contours for the purpose of coupling to two working tools that differ from each other in respect of a configuration of a shank.

Furthermore, it is proposed that the clamping unit has at least one working-tool locking element, which is provided for fixing on the working-tool receiving element a working tool that is coupled to the working-tool receiving element, at least in one operating state. Preferably, the working-tool locking element is provided to fix the working tool on the working-tool receiving element by means of a force-closure connection and/or by means of a form-closure connection. The working-tool locking element in this case is preferably realized as a fixing pin or as a fixing bolt. It is also conceivable, however, for the working-tool locking element to be of a different configuration, considered appropriate by persons skilled in the art, such as, for example, being configured as a clamping jaw, etc. Particularly preferably, a spring force of a further spring element of the clamping unit acts upon the working-tool locking element in the direction of the working tool that, at least in one operating state, is coupled to the working-tool receiving element. In this case, a spring force of the further spring element preferably acts at least substantially transversely in relation to a direction of movement of the variation element and/or to a direction of movement of the driving-force transmission element. By means of the configuration according to the disclosure it can be ensured, in a structurally simple manner, that force is reliably transmitted to a working tool that, at least in one operating state, is coupled to the working-tool receiving element.

Advantageously, the working-tool locking element engages in at least one fixing recess of the working tool, for the purpose of fixing the working tool coupled to the working-tool receiving element. Advantageously, therefore, a form-closure connection can be achieved for the purpose of fixing a working tool that, at least in one operating state, is coupled to the working-tool receiving element.

Further, the disclosure is based on a power tool, in particular a portable power tool comprising the power-tool clamping device according to the disclosure. A “portable power tool” is to be understood here to be, in particular, a power tool for working of workpieces, that can be transported by an operator without a transport machine. The portable power tool has, in particular, a mass of less than 40 kg, preferably less than 10 kg, and particularly preferably less than 5 kg. Particularly preferably, the portable power tool has at least one reciprocating drive unit. The portable power tool is therefore preferably realized as a saber saw. It is also conceivable, however, for the portable power tool to be of a different configuration, considered appropriate by persons skilled in the art, such as, for example, being configured as a compass saw, plunge-cut saw, hedge trimmer, etc. Advantageously, the configuration of the power tool according to the disclosure enables a high degree of operating comfort to be achieved. In addition, advantageously, a broad spectrum of application can be achieved for the power tool, owing to the possibility of coupling working tools that differ in respect of a configuration of a shank.

The power-tool clamping device according to the disclosure and/or the power tool according to the disclosure is/are not intended in this case to be limited to the application and embodiment described above. In particular, the power-tool clamping device according to the disclosure and/or the power tool according to the disclosure can have a number of individual elements, components and units that differs from a number stated herein, for the purpose of fulfilling a mode of functioning described herein.

### BRIEF DESCRIPTION OF THE DRAWINGS

Further advantages are given by the following description of the drawing. The drawing shows two exemplary embodiments of the disclosure. The drawing and the description below contain numerous features in combination. Persons skilled in the art will also expediently consider the features individually and combine them to create appropriate further combinations.

In the drawing:

FIG. 1 shows a power tool according to the disclosure, in a schematic representation,

FIG. 2 shows an exploded representation of a power-tool clamping device according to the disclosure, in a schematic representation,

FIG. 3 shows a detail view of the power-tool clamping device according to the disclosure in an uncoupled operating state, in a schematic representation,

FIG. 4 shows a detail view of the power-tool clamping device according to the disclosure in an operating state when coupled to a working tool, in a schematic representation,

FIG. 5 shows a detail view of the power-tool clamping device according to the disclosure in a further operating state when coupled to an alternative working tool, in a schematic representation,

FIG. 6 shows a detail view of an alternative power-tool clamping device according to the disclosure in an uncoupled operating state, in a schematic representation,

FIG. 7 shows a detail view of a variation element of the alternative power-tool clamping device according to the disclosure, in a schematic representation, and

FIG. 8 shows a further detail view of the variation element from FIG. 7, in a schematic representation.

### DETAILED DESCRIPTION

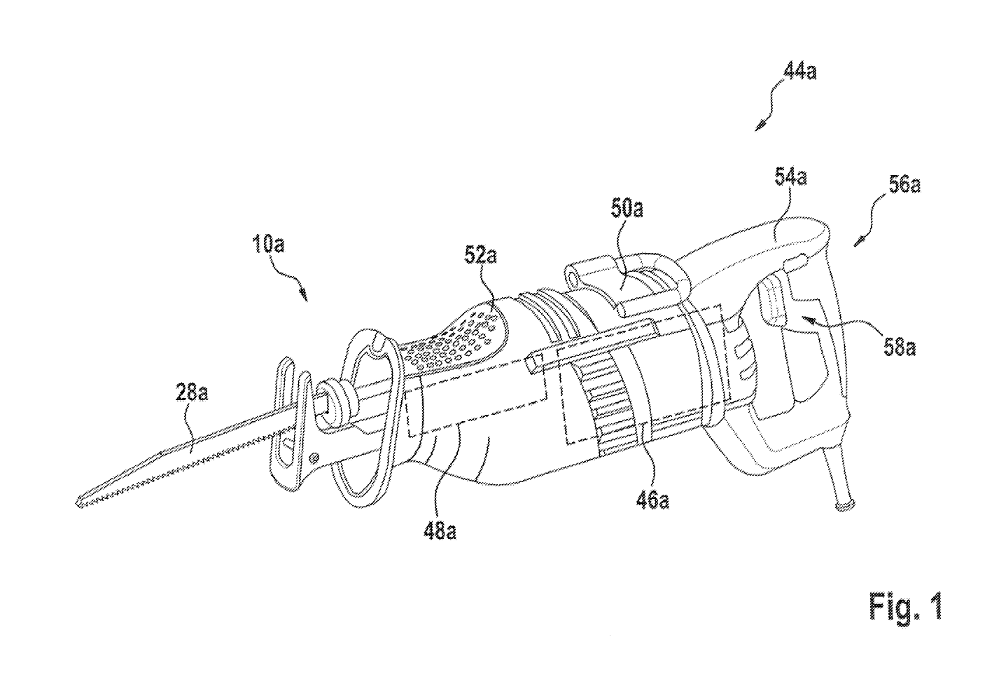

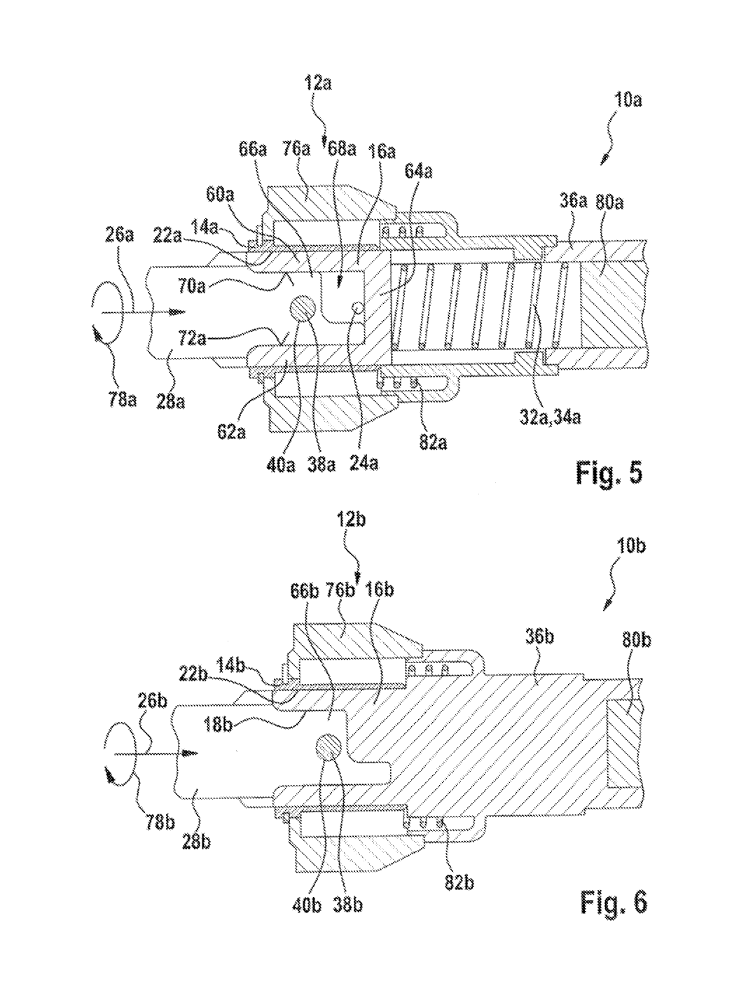

FIG. 1 shows a power tool 44a realized as a saber saw. The power tool 44a is thus constituted by a portable power tool. The power tool 44a in this case comprises a power-tool clamping device 10a for coupling at least one working tool 28a or a further working tool 30a to the power tool 44a. The working tool 28a is of a configuration that differs from the further working tool 30a. The working tool 28a in this case has at least one shank 66a that, in respect of dimensions, as viewed along at least two directions that run at least substantially perpendicularly in relation to each other, is realized such that it differs from a shank 74a of the further working tool 30a (FIGS. 4 and 5). It is conceivable in this case for the working tool 28a to be realized such that it additionally differs from the further working tool 30a in further parameters such as, for example, a cutting-edge shape, etc.

Further, the power tool 44a comprises a drive unit 46a and an output unit 48a. The drive unit 46a and the output unit 48a are provided to drive the working tool 28a or the further working tool 30a translationally, for the purpose of working a workpiece (not represented in greater detail here) by means of the power tool 44a, when the working tool 28a or the further working tool 30a has been fixed on the power-tool clamping device 10a. The power tool 44a additionally has at least one drive housing 50a and an output housing 52a. The drive housing 50a is provided to mount the drive unit 46a. The output housing 52a is provided to mount the output unit 48a. Further, the power tool 44a has a handle housing 54a, which is disposed, by means of a form-closure connection and/or a force-closure connection, on the drive housing 50a. The power tool 44a in this case can comprise a damping unit (not represented in greater detail here), which is provided to isolate, as far as possible, the handle housing 54a from the drive housing 50a in respect of vibration. The handle housing 54a in this case comprises a D-shaped grip region 56a, on which there is disposed, at least partially, a switching unit 58a for deactivating and/or starting up the power tool 44a. Further, the handle housing 54a is of a shell-type construction. It is also possible, however, for the handle housing 54a to be of a different configuration, considered appropriate by persons skilled in the art, such as, for example, a pot-type construction, or a combination of a shell-type and a pot-type construction.

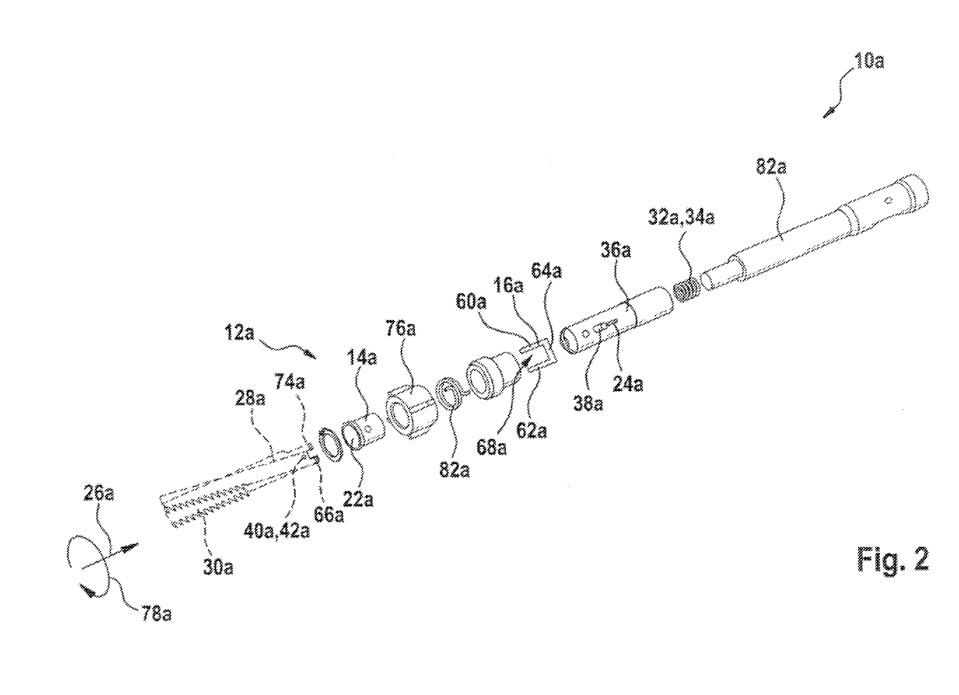

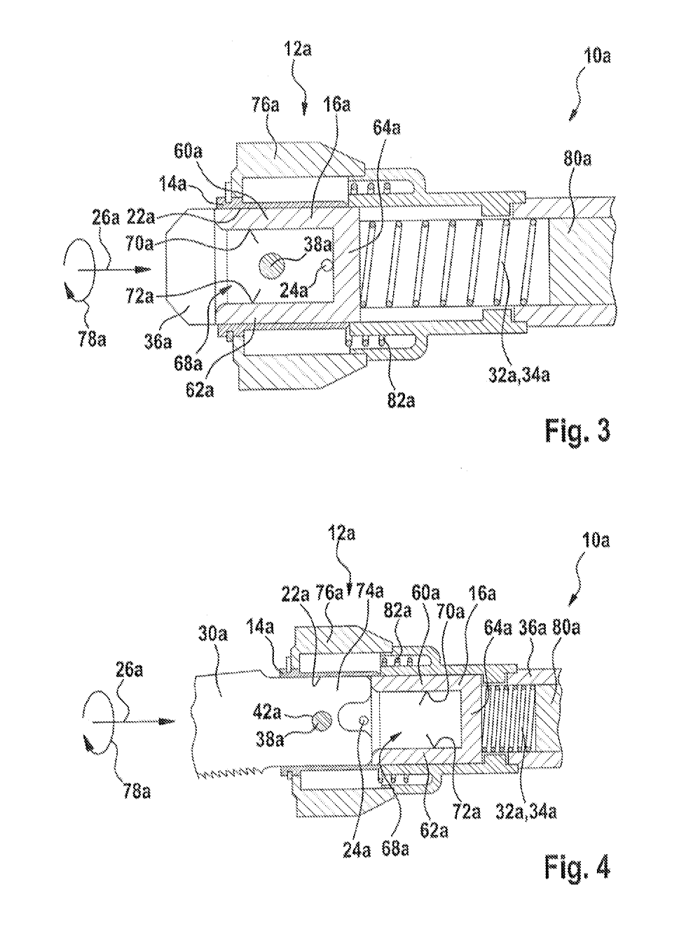

FIG. 2 shows an exploded representation of the power-tool clamping device 10a when demounted from the power tool 44a. The power-tool clamping device 10a comprises at least one clamping unit 12a, which has at least one working-tool receiving element 14a and has a variation element 16a, disposed on the working-tool receiving element 14a, for varying at least one parameter of the working-tool receiving element 14a. In addition, the power-tool clamping device 10a has at least one driving-force transmission element 36a, on which the working-tool receiving element 14a is disposed. The variation element 16a is movably mounted on the working-tool receiving element 14a (FIG. 3). The variation element 16a in this case is mounted so as to be translationally movable relative to the working-tool receiving element 14a. The variation element 16a is movably mounted in a working-tool receiving recess 22a of the working-tool receiving element 14a. The variation element 16a is thus provided to vary a parameter of the working-tool receiving element 14a, which parameter is realized as an inner dimension of the working-tool receiving recess 22a. As a result of this, the working tool 28a and, alternatively, the further working tool 30a, realized such that it differs from the working tool 28a, can be fixed on the power tool 44a by means of the power-tool clamping device 10a. The working-tool receiving recess 22a is thus provided to receive the shank 66a of the working tool 28a or, alternatively, the shank 74a of the further working tool 30a, in at least one operating state.

In at least one operating state of the clamping unit 12a, an outer contour of the shank 74a of the further working tool 30a in this case bears at least partially against an edge region of the working-tool receiving element 14a that delimits the working-tool receiving recess 22a (FIG. 4). A parameter of the working-tool receiving recess 22a that is realized as an inner dimension thus corresponds, at least substantially, to an outer dimension of the shank 74a of the further working tool 30a. As a result of this, at least three freedoms of movement of the shank 74a of the further working tool 30a are prevented by the working-tool receiving element 14a when the further working tool 30a has been coupled to the clamping unit 12a. Thus, when the further working tool 30a has been coupled to the clamping unit 12a, the working-tool receiving element 14a assumes at least three degrees of freedom of the shank 74a of the further working tool 30a.

The clamping unit 12a additionally has at least one energy storage element 32a, which applies a force to the variation element 16a in at least one direction oriented opposite to a coupling direction 26a of at least the working tool 28a or the further working tool 30a. For the purpose of being fixed on the power tool 44a by means of the power-tool clamping device 10a, the working tool 28a or the further working tool 30a are inserted axially, by the shank 66a of the working tool 28a or the shank 74a of the further working tool 30a, along the coupling direction 26a, into the working-tool receiving recess 22a. The energy storage element 32a is realized as a spring element 34a. The energy storage element 32a in this case is realized as a compression spring. The energy storage element 32a, realized as a spring element 34a, is supported by one end on the variation element 16a, and the energy storage element 32a, realized as a spring element 34a, is supported by a further end on a further driving-force transmission element 80a of the clamping unit 12a. The further driving-force transmission element 80a is connected by form closure and/or force closure to the driving-force transmission element 36a for the purpose of transmitting driving forces of the drive unit 46a.

Furthermore, the clamping unit 12a has at least one movement delimiting element 24a, which delimits a movement distance of the variation element 16a, as viewed along the direction oriented opposite to a coupling direction 26a of at least the working tool 28a or the further working tool 30a, relative to the working-tool receiving element 14a. In the case of a movement along the movement distance inside the working-tool receiving element 22a, the movement distance of the variation element 16a is thus delimited by the movement delimiting element 24a, as a result of a force of the energy storage element 32a, realized as a spring element 34a. The movement delimiting element 24a thus constitutes a securing element, which secures the variation element 16a at least in a captive manner on the working-tool receiving element 14a. The movement delimiting element 24a in this case is connected by form closure to the working-tool receiving element 14a. It is also conceivable, however, for the movement delimiting element 24a to be connected to the working-tool receiving element 14a by means of a different type of connection, considered appropriate by persons skilled in the art, such as, for example, by means of a force-closed or a materially bonded type of connection. The movement delimiting element 24a is realized as a pin or as a bolt, which extends into the working-tool receiving element 14a, along a at least substantially perpendicular to the direction of movement of the variation element 16a. As a result of this, a stop region of the clamping unit 12a is realized, for the purpose of delimiting a movement of the variation element 16a, as viewed along the direction oriented opposite to the coupling direction 26a of at least the working tool 28a or the further working tool 30a, relative to the working-tool receiving recess 22a of the working-tool receiving element 14a.

Further, the variation element 16a has a U-shaped configuration, as viewed in a plane in which a direction of movement of the variation element 16a runs. In this case, in respect of maximum extents, as viewed along at least two directions running at least substantially perpendicularly in relation to each other, a receiving region 68a of the variation element 16a corresponds to maximum extents of a shank 66a of the working tool 28a, as viewed along the at least two directions running at least substantially perpendicularly in relation to each other (FIG. 5). The receiving region 68a is provided to receive the shank 66a of the working tool 28a.

The receiving region 68a is encompassed by two limbs 60a, 62a of the variation element 16a, which extend at least substantially parallelwise in relation to each other, and by a further limb 64a of the variation element 16a, which extends at least substantially perpendicularly in relation to the limbs 60a, 62a that extend substantially parallelwise in relation to each other. The variation element 16a thus has at least the receiving region 68a that is delimited by the limbs 60a, 62a and the further limb 64a of the variation element 16a, at least in two directions, differing from each other, which run at least substantially transversely in relation to each other. When the working tool 28a has been coupled to the clamping unit 12a, the variation element 16a bears at least partially, by mutually facing sides 70a, 72a of the limbs 60a, 62a that extend at least substantially parallelwise in relation to each other, and by a partial region of the further limb 64a, against an outer contour of the shank 66a of the working tool 28a (FIG. 5). It is also conceivable, however, for the mutually facing sides 70a, 72a of the limbs 60a, 62a that extend at least substantially parallelwise in relation to each other, and the further limb 64a, to bear by at least one side completely against the outer contour of the shank 66a of the working tool 28a when the working tool 28a has been coupled to the clamping unit 12a.

Furthermore, the clamping unit 12a has at least one working-tool locking element 38a, which is provided for fixing on the working-tool receiving element 14a the working tool 28a that is coupled to the working-tool receiving element 14a, or the further working tool 30a that is coupled, instead of the working tool 28a, to the working-tool receiving element 14a, at least in one operating state. In this case, for the purpose of fixing the working tool 28a, or the further working tool 30a, that is coupled to the working-tool receiving element 14a, the working-tool locking element 38a engages in at least one fixing recess 40a of the working tool 28a or in at least one fixing recess 42a of the further working tool 30a.

The working-tool locking element 38a is realized as a pin, which is movably disposed on a clamping element 76a of the clamping unit 12a. The clamping element 76a is realized as a clamping sleeve, which encompasses the working-tool receiving element 14a along a circumferential direction 78a running in a plane that extends at least substantially perpendicularly in relation to the coupling direction 26a. The clamping element 76a in this case is mounted on the working-tool receiving element 14a so as to be movable, along the circumferential direction 78a, relative to the working-tool receiving element 14a. By means of a torsion spring element 82a, a spring force is applied to the clamping element 76a, along the circumferential direction 78a. In addition, on a side that faces toward working-tool receiving element 14a, the clamping element 76a has a control curve (not represented in greater detail here) for moving the working-tool locking element 38a in dependence on a rotary movement of the clamping element 76a relative to the working-tool receiving element 14a, in a manner already known to persons skilled in the art. The working-tool locking element 38a in this case can be disposed, by one end, in a form-closed manner in a control curve realized as a groove, or the working-tool locking element 38a can slide under spring load on an outer contour of the control curve, the outer contour having differing distances to a rotation axis of the clamping element 76a, in dependence on a rotary position of the clamping element 76a.

For the purpose of fixing the working tool 28a, the clamping element 76a is rotated into an insertion position. As a result of this, the working-tool locking element 38a is likewise moved into an insertion position, and the working-tool receiving recess 22a is released for the purpose of inserting the shank 66a of the working tool 28a. The working tool 28a can thus be pushed, by the shank 66a of the working tool 28a, along the coupling direction 26a, into the working-tool receiving recess 22a. As a result of this, the shank 66a is pushed into the receiving region 68a of the variation element 16a. The clamping element 76a is brought into a clamping position by the torsion spring element 82a, after an actuating force of an operator upon the clamping element 76a is removed. As a result of this, the working-tool locking element 38a is introduced into the fixing recess 40a of the working tool 28a by means of the control curve, in a manner already known to persons skilled in the art. The working tool 28a thus becomes fixed on the power tool 44a.

For fixing the further working tool 30a, instead of the working tool 28a, on the power tool 44a, the procedure is as already described in the preceding paragraph. In this case, as the further working tool 30a is introduced along the coupling direction 26a into the working-tool receiving recess 22a, the variation element 16a is moved by the introduction of the shank 74a of the further working tool 30a, contrary to a force of the energy storage element 32a, realized as a spring element 34a, until the working-tool locking element 38a can be introduced into the fixing recess 42a of the further working tool 30a, for the purpose of fixing the further working tool 30a (FIG. 4). As a result of this, the energy storage element 32a, realized as a spring element 34a, is compressed.

FIGS. 6 to 8 show an alternative exemplary embodiment. Components, features and functions that remain substantially the same are denoted, basically, by the same references. In order to differentiate the exemplary embodiments, the references of the exemplary embodiments have the suffix letters a and b. The description that follows is limited substantially to the differences in relation to the first exemplary embodiment in FIGS. 1 to 5, and reference may be made to the description of the first exemplary embodiment in FIGS. 1 to 5 in respect of components, features and functions that remain the same.

FIG. 6 shows a power-tool clamping device 10b that is an alternative to the power-tool clamping device 10a described in FIGS. 1 to 5. The power-tool clamping device 10b comprises at least one clamping unit 12b, which has at least one working-tool receiving element 14b and has a variation element 16b, disposed on the working-tool receiving element 14b, for varying at least one parameter of the working-tool receiving element 14b. The variation element 16b has at least two mutually differing working-tool receiving contours 18b, 20b. In this case, one of the working-tool receiving contours 18b, 20b is provided to receive a shank 66b of a working tool 28b. In addition, one of the working-tool receiving contours 18b, 20b is provided, instead of receiving the shank 66b of the working tool 28b, to receive a shank of a further working tool (not represented in greater detail here), which is realized differently, at least in respect of an outer contour of the shank or in respect of maximum dimensions along at least two directions that run differently from each other.

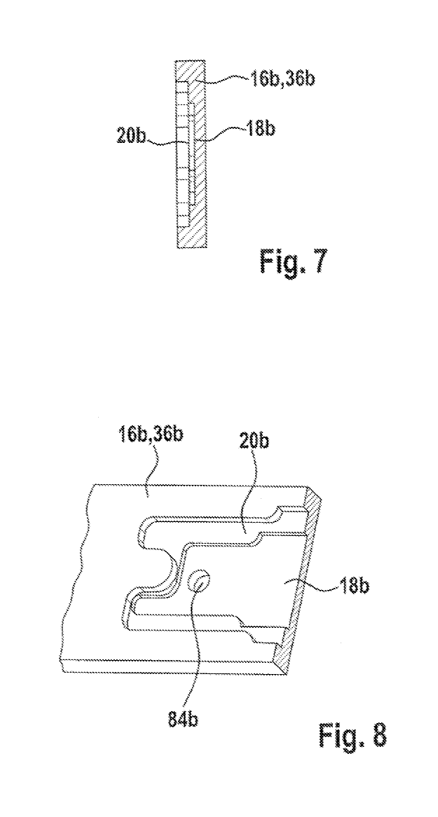

The power-tool clamping device 10b additionally has at least one driving-force transmission element 36b, the variation element 16b being realized so as to be integral with the driving-force transmission element 36b. A working-tool receiving recess 22b of the working-tool receiving element 14b thus constitutes bearing contact surfaces, against which there bears the variation element 16b, realized so as to be integral with the driving-force transmission element 36b. Further, the variation element 16b has a lead-through recess 84b (FIG. 8). The lead-through recess 84b is provided to enable a working-tool locking element 38b of the clamping unit 12b to engage in a fixing recess 40b of the working tool 28b, or in a fixing recess (not represented in greater detail here) of the further working tool, for the purpose of fixing the working tool 28b or the further working tool. The driving-force transmission element 36b is realized as a lift rod. In this case, the mutually differing working-tool receiving contours 18b, 20b are disposed so as to be offset in an at least substantially parallel manner in relation to each other (FIG. 7). One of the working-tool receiving contours 18b, 20b in this case has an inner contour that corresponds to an outer contour of the shank 66b of the working tool 28b, and one of the working-tool receiving contours 18b, 20b has an inner contour that corresponds to an outer contour of the shank of the further working tool that can be coupled, instead of the working tool 28b, to the power-tool clamping device 10b (FIG. 8). The alternative power-tool clamping device 10b thus has a configuration of the clamping unit 12b that is decoupled from an energy storage element and from a movement delimiting element.

1. A clamping device of a reciprocating power tool comprising:
at least one clamping unit including:
at least one working-tool receiving element; and
a variation element disposed on the at least one working-tool receiving element and configured to vary at least one parameter of the at least one working-tool receiving element, wherein:
the variation element is movably mounted on the at least one working-tool receiving element and/or has at least two mutually differing working-tool receiving contours.

2. The power-tool clamping device according to claim 1, wherein the variation element is movably mounted in a working-tool receiving recess of the at least one working-tool receiving element.

3. The power-tool clamping device according to claim 1, wherein the at least one clamping unit has at least one movement delimiting element configured to delimit a movement distance of the variation element along a direction oriented opposite to a coupling direction of at least one working tool, relative to the at least one working-tool receiving element.

4. The power-tool clamping device according to claim 1, wherein the at least one clamping unit has at least one energy storage element configured to apply a force to the variation element in at least one direction oriented opposite to a coupling direction of at least one working tool.

5. The power-tool clamping device according to claim 4, wherein the at least one energy storage element is a spring element.

6. The power-tool clamping device according to claim 1, further comprising:
at least one driving-force transmission element, the variation element being integral with the at least one driving-force transmission element.

7. The power-tool clamping device according to claim 1, wherein the mutually differing working-tool receiving contours are disposed so as to be offset in an at least substantially parallel manner in relation to each other.

8. The power-tool clamping device according to claim 1, wherein the at least one clamping unit has at least one working-tool locking element configured to fix on the at least one working-tool receiving element a working tool that is coupled to the at least one working-tool receiving element, at least in one operating state.

9. The power-tool clamping device according to claim 8, wherein the at least one working-tool locking element engages in at least one fixing recess of the working tool to fix the working tool coupled to the at least one working-tool receiving element.

10. A portable power tool comprising:
a power-tool clamping device including:
at least one clamping unit having at least one working-tool receiving element and a variation element disposed on the at least one working-tool receiving element and configured to vary at least one parameter of the at least one working-tool receiving element, wherein the variation element is movably mounted on the at least one working-tool receiving element and/or has at least two mutually differing working-tool receiving contours.
